(19) United States
(12) Patent Application Publication
(10) Pub. No.: US 2025/0063515 A1
(43) Pub. Date: Feb. 20, 2025

(54) DETERMINING PROXY DEVICE TRANSMIT POWER USING SIGNAL STRENGTH INFORMATION FROM ORIGIN DEVICE

(71) Applicant: Samsung Electronics Co., Ltd., Suwon-si (KR)

(72) Inventors: Matthew Tonnemacher, Allen, TX (US); Bilal Sadiq, Plano, TX (US)

(21) Appl. No.: 18/759,264

(22) Filed: Jun. 28, 2024

Related U.S. Application Data
(60) Provisional application No. 63/533,459, filed on Aug. 18, 2023.
(60) Provisional application No. 63/533,849, filed on Aug. 21, 2023.

(51) Int. Cl. H04W 52/24; H04W 8/00

(52) U.S. Cl. CPC H04W 52/245; H04W 8/005; H04W 52/242

(57) ABSTRACT

An embodiment includes a method for messaging in a wireless network that includes receiving, by a proxy device for an origin device, a first message from the origin device, wherein the first message includes a reference transmit power of the origin device and the first message is received with a received power, computing, by the proxy device, a transmit power for transmitting messages on behalf of the origin device based on the reference transmit power and the received power, and transmitting at the transmit power, by the proxy device, a second message that includes information about a service provided by the origin device.

### CROSS-REFERENCE TO RELATED APPLICATIONS

This application claims the benefit of priority from U.S. Provisional Application No. 63/533,459, entitled “USING CLIENT PROXIMITY TO ADJUST PROXY ADVERTISEMENT FOOTPRINT” filed Aug. 18, 2023, U.S., and U.S. Provisional Application No. 63/533,849, entitled “USING CLIENT PROXIMITY TO ADJUST PROXY ADVERTISEMENT FOOTPRINT” filed Aug. 21, 2023, all of which are incorporated herein by reference in their entireties.

### TECHNICAL FIELD

This disclosure relates generally to a wireless communication system, and more particularly to, for example, but not limited to, determining proxy device transmit power using signal strength information from an origin device.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

Wi-Fi Aware, also known as Neighbor Awareness Networking (NAN), is a specification put forward by the Wi-Fi Alliance that focuses on ad-hoc peer to peer (P2P) networking. The specification allows devices to connect with each other to fulfill specific service-based needs. A feature of this specification is Discovery. NAN Discovery may be handled by a NAN Discovery Engine, and can include publishing services advertisements for devices in a NAN network. NAN service advertisements are typically transmitted multiple times (e.g., periodically) by a device in a NAN cluster. A device offering/requesting a service may do the service advertisement. Many devices have limited power, so frequently transmitting advertisements can be a costly activity.

There are numerous ways to publish services advertisements. For example, a NAN device can initiate periodic publish messages to solicit a subscription to the service(s). Conversely, a NAN device can instead initiate by repeatedly (e.g., periodically) sending subscribe messages to search for another device offering specific services. In either case, to increase the likelihood of finding a matching publisher/subscriber, these messages may need to be sent repeatedly for an extended time.

The description set forth in the background section should not be assumed to be prior art merely because it is set forth in the background section. The background section may describe aspects or embodiments of the present disclosure.

### SUMMARY

One aspect of the present disclosure provides a method for messaging in a wireless network. The method comprises receiving, by a proxy device for an origin device, a first message from the origin device, wherein the first message includes a reference transmit power of the origin device and the first message is received with a received power. The method comprises computing, by the proxy device, a transmit power for transmitting messages on behalf of the origin device based on the reference transmit power and the received power. The method comprises transmitting at the transmit power, by the proxy device, a second message to a plurality of devices that includes information about a service provided by the origin device.

In some embodiments, the received power is based on a received signal strength of the first message.

In some embodiments, the transmit power is computed such that the second message is received by a set of neighboring devices to the origin device.

In some embodiments, the set of neighboring devices to the origin device are determined based on ranging information provided in Neighbor Awareness Networking (NAN).

In some embodiments, the transmit power is computed such that the second message is received by a set of neighboring devices that are in common to the origin device and the proxy device.

In some embodiments, the first message includes information on one or more devices neighboring the origin device, where the method further comprises comparing, by the proxy device, one or more neighboring devices between the proxy device and the origin device to determine the set of neighboring devices that are in common to the origin device and the proxy device and to determine a set of neighboring devices that are exclusive to the proxy device, and computing, by the proxy device, the transmission power to include the set of neighboring devices that are in common and to exclude the set of neighboring devices that are exclusive to the proxy device.

In some embodiments, the first message includes signal strength information for a set of neighboring devices of the origin device and the second message includes the signal strength information for the set of neighboring devices of the origin device.

In some embodiments, the method further comprises determining a signal strength threshold for transmitting a message for the origin device by: computing an estimate path lost between the origin device and the proxy device based on a difference between the transmit power and the received power, computing a target maximum distance for transmitting messages as a function of the estimated path loss, setting the signal strength threshold for received power for devices receiving the second message equal to a distance between the transmit power of the proxy device and expected receive power for the target maximum distance and including the signal strength threshold in the second message.

In some embodiments, the method further comprises receiving, by the proxy device, a third message from a different origin device, and transmitting, by the proxy device, a fourth message that includes information about the service provided by the origin device and information about a service provided by the different origin device.

In some embodiments, the method further comprises using a machine learning model to determine the transmit power.

One aspect of the present disclosure provides a first station (STA) in a wireless network. The first STA comprises a memory and a processor coupled to the memory. The processor is configured to receive, a first message from a second STA, wherein the first message includes a reference transmit power of the second STA and the first message is received with a received power. The processor is configured to compute a transmit power for transmitting messages on behalf of the second STA based on the reference transmit power and the received power. The processor is configured to transmit at the transmit power a second message to a plurality of STAs that includes information about a service provided by the second STA.

In some embodiments, the received power is based on a received signal strength of the first message.

In some embodiments, the transmit power is computed such that the second message is received by a set of neighboring STAs to the second STA.

In some embodiments, the set of neighboring STAs to the second STA device are determined based on ranging information provided in Neighbor Awareness Networking (NAN).

In some embodiments, the transmit power is computed such that the second message is received by a set of neighboring STAs that are in common to the first STA device and the second STA.

In some embodiments, the first message includes information on one or more STAs neighboring the second STA, wherein the processor is further configured to compare neighboring STAs between the first STA and the second STA to determine the set of neighboring STAs that are in common to the first STA and the second STA and to determine a set of neighboring STAs that are exclusive neighbors to the first STA, and compute the transmission power to include the set of neighboring STAs that are in common and to exclude the set of neighboring STAs that are exclusive neighbors to the first STA.

In some embodiments, the first message includes signal strength information for a set of neighboring STAs of the second STA and the second message includes the signal strength information for the set of neighboring STAs of the second STA.

In some embodiments, the processor is further configured to determine a signal strength threshold for transmitting a message for the second STA by computing an estimate path lost between the second STA device and the first STA based on a difference between the transmit power and the received power, computing a target maximum distance for transmitting messages as a function of the estimated path loss, setting the signal strength threshold for received power for STAs receiving the second message equal to a distance between the transmit power of the first STA and expected receive power for the target maximum distance, and including the signal strength threshold in the second message

In some embodiments, the processor is further configured to receive a third message from a third STA, and transmit a fourth message that includes information about the service provided by the second STA and information about a service provided by the third STA.

In some embodiments, the processor is further configured to use a machine learning model to determine the transmit power.

### BRIEF DESCRIPTION OF THE DRAWINGS

FIG. 1 illustrates an example of a wireless network in accordance with an embodiment.

FIG. 2A illustrates an example of AP in accordance with an embodiment.

FIG. 2B illustrates an example of STA in accordance with an embodiment.

FIG. 3 illustrates an example of multi-link communication operation in accordance with an embodiment.

FIG. 4 illustrates an architecture of a Neighbor Awareness Networking (NAN) engine in accordance with an embodiment.

FIG. 5 illustrates spatial radio frequency (RF) footprints of origin devices and proxy devices in accordance with an embodiment.

FIG. 6 illustrates transmit (TX) power regions of origin and proxy devices in accordance with an embodiment.

FIG. 7 illustrates extending a proxy advertisement range to encompass more devices within the discovery footprint of an origin device in accordance with an embodiment.

FIG. 8 illustrates an example flow chart for proxy power control calibration for radio devices in accordance with an embodiment.

FIG. 9 illustrates an example communication for proxy power control calibration within NAN service discovery in accordance with an embodiment.

FIG. 10 illustrates discovery regions for proxy power control calibration in accordance with an embodiment.

FIG. 11 illustrates an example flowchart for proxy power control calibration for radio devices using shared neighbor device information in accordance with an embodiment.

FIG. 12 illustrates an example communication for proxy power control calibration within NAN service discovery in accordance with an embodiment.

FIG. 13 illustrates proxy advertisement power adjustment configurations in accordance with an embodiment.

FIG. 14 illustrates an example flowchart for proxy device discovery control for radio devices through an eligible devices field using shared neighbor device information in accordance with an embodiment.

FIG. 15 illustrates an example communication for proxy device discovery control through an eligible devices field within NAN Service Discovery using shared neighboring device information in accordance with an embodiment.

FIG. 16 illustrates an example flowchart for proxy device discovery control for radio devices through an eligible range field using origin device received signal strength in accordance with an embodiment.

FIG. 17 illustrates an example communication for proxy device discovery control through an eligible range field within NAN service discovery using origin device received signal strength in accordance with an embodiment.

FIG. 18 illustrates an example communication for proxy device discovery in accordance with an embodiment.

FIG. 19 illustrates an example flowchart for reception of a proxy discovery message and discovery event decision using range restriction in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

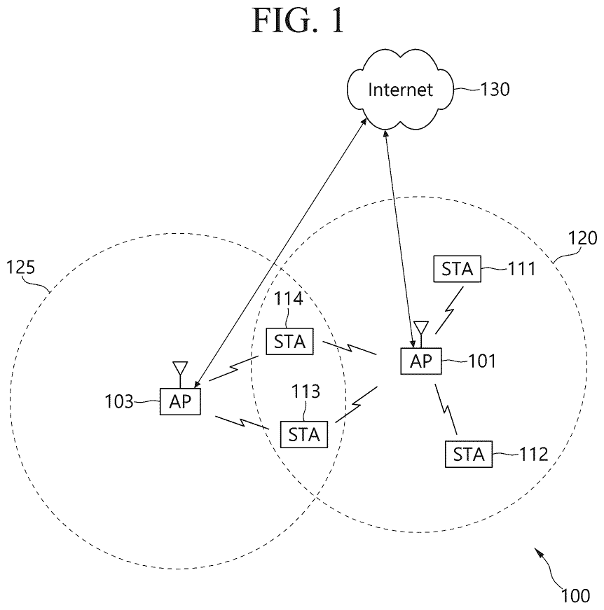

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

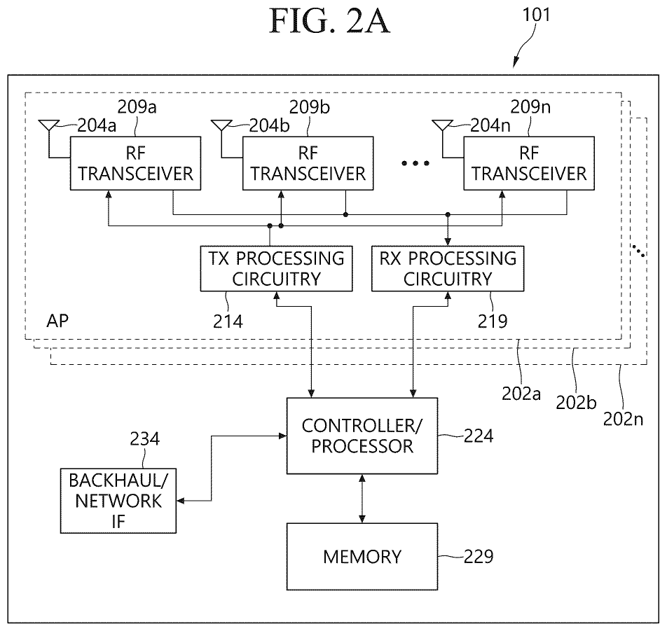

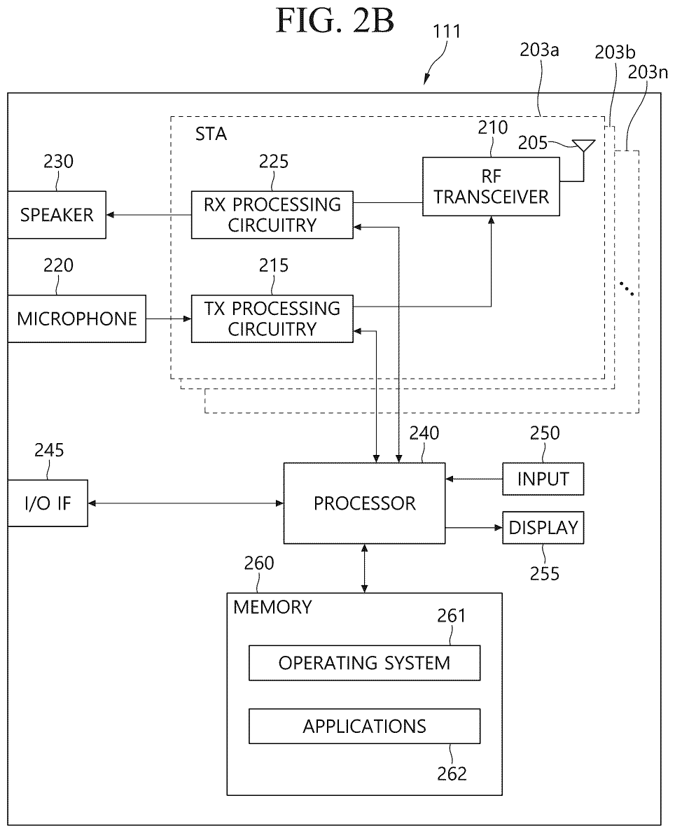

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

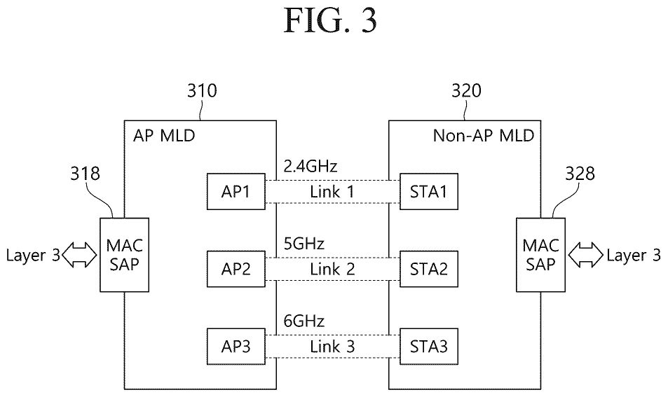

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA I may set up Link I which operates in 2.4 GHz band. Similarly, the AP 2 and the STA 2 may set up Link 2 which operates in 5 GHZ band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

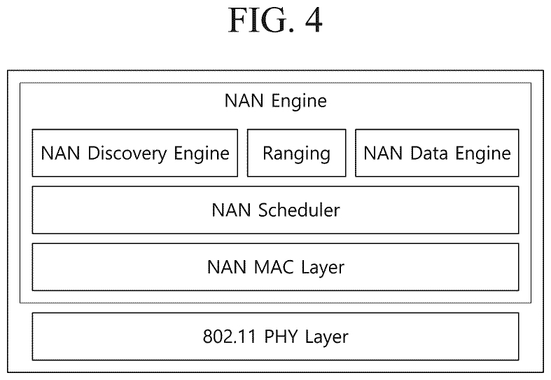

FIG. 4 illustrates an architecture of a NAN engine in accordance with an embodiment. The NAN engine may include a NAN discovery engine module, a Ranging module, a NAN Data Engine module, a NAN Scheduler module, a NAN Medium Access Control (Mac) layer module, and an 802.11 PHY Layer module.

The NAN discovery engine may be responsible for discovering devices and/or services made available on devices for specific services through Publish and Subscribe messages. Publish messages may advertise a service(s) offered by a NAN device and subscribe messages may advertise a willingness to engage with a device that offers a service(s).

The Ranging module may estimate the distance between NAN Devices that support the ranging capability. Ranging may be used in addition to the service discovery mechanism to estimate the distance to a NAN device providing a specific service. The NAN Data Engine module may provide the NAN Data Link (NDL) capability that may be used to setup a data link between NAN Devices. The NAN Scheduler module may establish, maintain, and terminate Wi-Fi radio resource schedules for NAN operations. The NAN Scheduler module may also be responsible for coordinating concurrent NAN and Non-NAN operations. The NAN MAC layer module may process and handle the NAN Beacon frames and NAN Service Discovery frames. The 802.11 PHY Layer module may provide data transport services to higher layers.

There are numerous ways to accomplish a publish/subscribe handshake. For example, a NAN device can initiate periodic publish messages to solicit a subscription to the service(s). Conversely, a NAN device can instead initiate by repeatedly (e.g., periodically) sending subscribe messages to search for another device offering specific services. In either case, to increase the likelihood of finding a matching publisher/subscriber, these messages may need to be sent repeatedly for an extended time.

Some embodiments may provide a proxy device that can publish/subscribe on behalf of one or more other devices. This may provide several benefits including saving on channel congestion (e.g., in the case multiple devices using one proxy) or allowing the origin devices to save power.

Several embodiments in accordance with this disclosure may provide improved discovery of nearby devices, and/or the services made available by nearby devices, when using a proxy device for publication/subscription discovery messaging. Embodiments in accordance with this disclosure may be applicable to discovery supported by various technologies such as Wi-Fi Neighbor Awareness Networking (NAN), Bluetooth, LTE sidelink, among others.

NAN service advertisement is typically transmitted multiple times (e.g., periodically) by a device in a NAN cluster. A device offering/requesting a service may do the service advertisement. Many devices have limited power, so frequently transmitting advertisements can be a costly activity.

Some embodiments may aggregate device service advertisements to a single proxy device which may reduce wireless channel congestion/contention. Some embodiments may allow another NAN device to perform ‘proxy advertisements.’ In some embodiments, a proxy NAN device, which might not have the same power limitations as the origin NAN device, may transmit NAN service advertisements in place of or in addition to the origin device.

Proxy advertisement, however, may present a potential problem when it comes to the connectivity range of the origin device. Since the origin device and proxy device may not be necessarily co-located and the transmit power capabilities may be different between them as well, the spatial RF footprint, such as coverage or detection region, of the proxy advertisements may not necessarily be the same as that of the origin device.

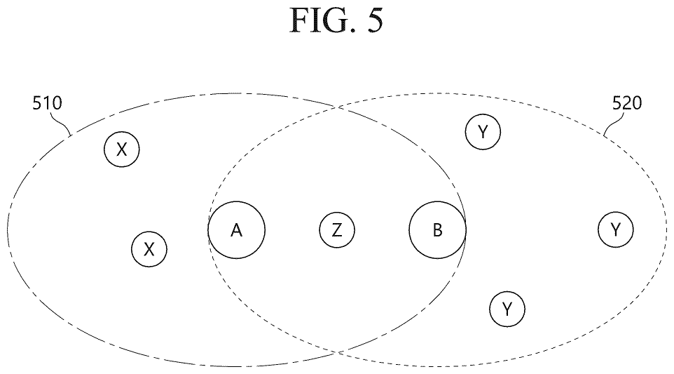

FIG. 5 illustrates spatial RF footprints of origin devices and proxy devices in accordance with an embodiment. In particular, in FIG. 5, origin Device A uses a proxy device B. Origin device A is in range of X devices and Z devices, but not Y devices, illustrated by region 510. However, proxy device B is in the range of Y and Z devices, illustrated by region 520. This may be problematic for several reasons. First, X devices may not receive the proxy advertisement, even though they are in range of origin device A. Secondly, Y devices may receive the proxy advertisement, but may be unable to reach origin device A (e.g., with their follow-up messaging) which may result in wasted time, unnecessary power consumption, and/or congestion on the medium.

These problems may extend beyond Wi-Fi Aware/NAN networks and into any technologies that support neighbor discovery. Differences in spatial RF footprints between the origin and proxy devices may lead to several issues, as described below.

In particular, other devices that hear the advertisement may not be in range of the origin device and unable to communicate with the origin device (e.g., to request further discovery or other information, or to set up a data path.) Furthermore, other devices that are in advertisement range of the origin device may not hear advertisements from the proxy device.

Some embodiments may solve connectivity issues brought about by differences in origin device and proxy device's advertisement spatial RF footprints by using a power control scheme to adjust a proxy device's advertisement transmit power. Adjusting a proxy device's transmit power may avoid misleading other devices that are within range of the proxy device but not in range of the origin device (such as, devices Y in FIG. 5). In other words, reducing the ‘false detection’ rate of a potential device discovery event. Using a power control scheme may also avoid missing potential device discovery events with devices that are in range of the origin device but not in range of the proxy device. Some embodiments may set the proxy device transmit power or otherwise limiting eligible service subscribers/publishers based on one or more of the following described below.

Some embodiments may use a signal strength metric of one or more messages that the proxy device receives from the origin device. The signal strength metric may be based on one of an RSSI or SNR of a received message. The metric may further be based on a receive configuration of the proxy device, such as a number of diversity branches, receive antennas, among others. For example, the signal strength metric may be determined based on the signal strength of all diversity branches.

Some embodiments may use ranging information that the proxy device receives from the origin device and from other neighboring devices. In some embodiments, the proxy device transmit power may be set to specifically include or exclude a subset of neighboring devices. In some embodiments, the proxy device may artificially limit the devices suitable for connection by providing range restrictions within service discovery messaging.

Some embodiments may use a set of devices (or services) discovered by the origin device and a set of devices (or services) discovered by the proxy device. For example, based on the intersection or the set difference of the two sets. The proxy device transmit power may further depend on a signal strength metric associated with each device in the two sets, where the signal strength metric may be based on the discovery message received from the device. For example, the proxy device may determine its TX power such that the proxy-transmitted message may be received successfully by devices in the intersection of the two sets but unlikely to be received successfully by the devices in the set difference (proxy device's set—origin device's set). For example, the proxy device may determine its TX power such that the proxy-transmitted message may be received successfully by all (or as many as possible, if max TX power is still not sufficient to reach all) devices in the origin device's set.

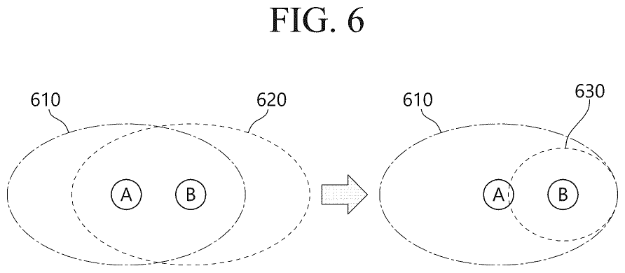

FIG. 6 illustrates TX power regions of origin and proxy devices in accordance with an embodiment. In particular, FIG. 6 illustrates origin device A and proxy device B with dash-dot regions, with origin device A having discovery footprint of region 610, and proxy device B having discovery footprint of region 620, which show the set of devices discovered by origin/proxy device respectively. These may be referred to as the discovery footprint of the corresponding device. Some embodiments may limit a proxy advertisement range to within an origin node's discovery footprint. As illustrated, the proxy device may determine its TX power such that the proxy-transmitted message may be received successfully by devices in the intersection, illustrated as region 630, of the two sets but unlikely to be received successfully by the devices in the set difference (proxy device's set—origin device's set).

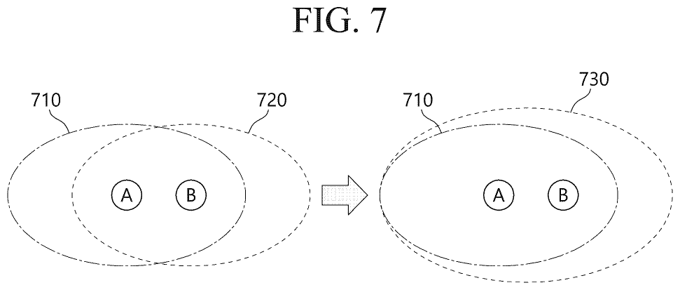

FIG. 7 illustrates extending a proxy advertisement range to encompass more devices within the discovery footprint of an origin device in accordance with an embodiment. In particular, FIG. 7 illustrates origin device A and proxy device B, with the dash-dot regions, with origin Device A having discovery footprint region 710, and proxy device B having discovery footprint of region 720, which show the set of devices discovered by origin/proxy device respectively. As illustrated, the proxy device, device B, may determine its TX power such that the proxy-transmitted message may be received successfully by all (or as many as possible, if max TX power is still not sufficient to reach all) devices, illustrated as region 730, in the origin device's set (origin device A's set 710).

Some embodiments may set a proxy advertisement transmit power as a function of the proxy device's received power from the origin device and the transmit power of the origin device. In some embodiments, no coordination may be needed from other devices other than the origin device and the proxy device. The proxy device may simply record the received signal strength from messages sent by the origin device, parse out the origin device's reported transmit power in the discovery message(s), and adjust its own transmit power as a function of the these.

In some embodiments, how this function may be used may depend on the intended outcome of the solution. In some embodiments, the transmit power of the origin device and its received power at the proxy device can be used to determine the shortest and/or longest distances, where distance may be in terms of path loss, from the proxy device that the origin device could establish a data connection. The function itself may include scaling factors, offsets, path loss models, or other adjustments to improve performance for specific deployment topologies. In some embodiments, the function may also be a machine learning/AI driven model with a combination or subset of the aforementioned parameters.

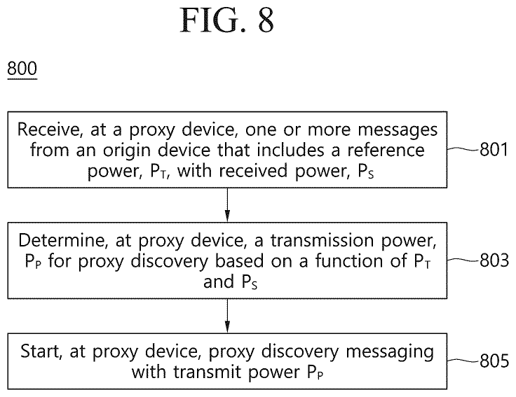

FIG. 8 illustrates an example flow chart for proxy power control calibration for radio devices in accordance with an embodiment. The process 800 at operation 801 receives, at a proxy device, one or more messages from an origin device that includes a reference power, P_{T}, with a received power, P_{S}.

At operation 803, the proxy device determines a transmission power, P_{P}, for proxy discovery based on a function of P_{T} and P_{S}.

At operation 805, the proxy device starts proxy discovery messaging with transmit power P_{P}.

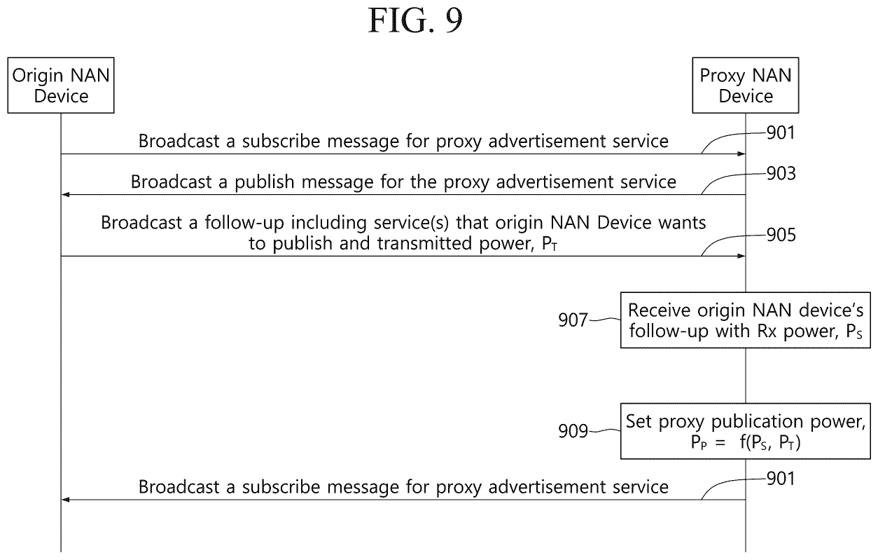

FIG. 9 illustrates an example communication for proxy power control calibration within NAN service discovery in accordance with an embodiment. P_{T} is the power transmitted by the origin device, P_{S} is the received subscribe message power, and P_{P} is the derived proxy publish message power.

At 901, the origin NAN device broadcasts a subscribe message for proxy advertisement service to the proxy NAN device.

At 903, the proxy NAN device broadcasts a publish message for the proxy advertisement service to the origin NAN device.

At 905, the origin NAN device broadcasts a follow-up including service(s) that the origin NAN device wants to publish and transmitted power, P_{T}.

At 907, the proxy NAN device receives the origin NAN device's follow-up with Rx power, P_{S}.

At 909, the proxy NAN device sets proxy publication power, P_{P}=f(P_{S}, P_{T}).

At 911, the proxy NAN device broadcasts a follow-up message acknowledgement to the origin NAN device.

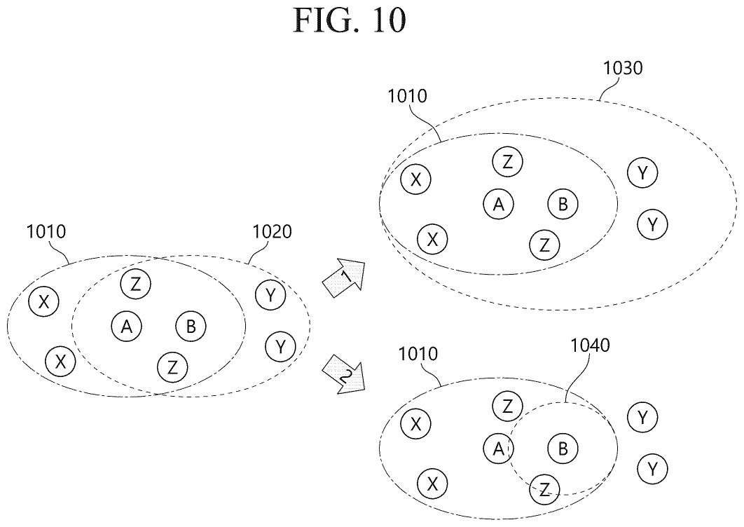

FIG. 10 illustrates discovery regions for proxy power control calibration in accordance with an embodiment. In particular, in FIG. 10, in the left half of the figure, origin device, A, uses a proxy device, B. Device A is in range of X devices and Z devices, but not Y devices, as illustrated by discovery region 1010. Device B is in range of Z devices and Y devices, as illustrated by discovery region 1020.

This may be the standard configuration. On the right half of FIG. 10, two situations of the proxy advertisement power adjustment are shown. The first, denoted by arrow 1, shows the advertisement footprint of proxy device B, illustrated as region 1030 extending to cover all devices in range of device A. The region of device A is illustrated as region 1010.

The second, denoted by arrow 2, shows the advertisement footprint of proxy device B, illustrated as region 1040, contracting to limit the range to within device A's connectivity footprint, illustrated as region 1010. These may be both extremes. In some embodiments, a more balanced approach may be taken as well, resulting in an advertisement footprint between the two extremes.

In some embodiments, the proxy device may use the set of neighboring devices of both the origin device and proxy device to set proxy advertisement transmit power. A ranging architecture may be used to determine distances between devices. Each NAN device may have knowledge of neighbors as part of normal NAN operation (such as synchronization, NAN discovery beacons, service discovery, among others).

In some embodiments, the origin device may share the set of its neighboring devices with the proxy device. The origin device may additionally share a signal strength metric for one or more devices in the neighboring devices set. The set of neighboring devices may be based on device ranging and/or it may be based on other signals received from the neighboring devices, such as synchronization beacons, discovery beacons, and/or discovery messages, among others. With information on the origin device's neighboring device set, the proxy device can cross-reference with its own neighboring device information to derive a new set of devices that is the intersection of the origin and proxy device's neighboring device sets. The proxy device can control advertisement power to either include origin-only devices, exclude proxy-only devices, or a balanced approach that maximizes a more complex objective function.

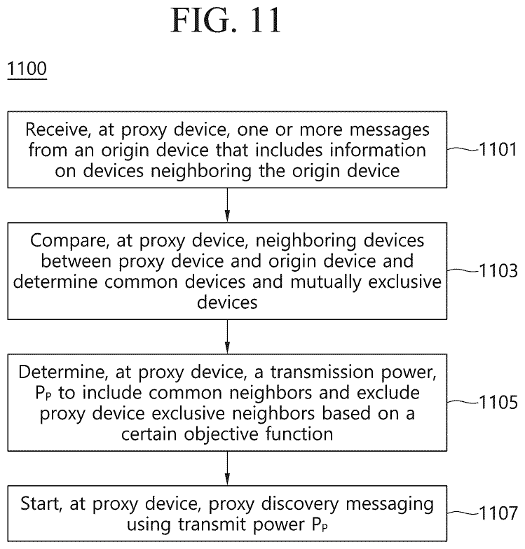

FIG. 11 illustrates an example flowchart for proxy power control calibration for radio devices using shared neighbor device information in accordance with an embodiment.

In operation 1101, the proxy device receives one or more messages from an origin device that includes information on devices neighboring the origin device.

In operation 1103, the proxy device compares neighboring devices between the proxy device and the origin device and determines common devices and mutually exclusive devices.

In operation 1105, the proxy device determines a transmission power, P_{P}, to include common neighbors and exclude proxy device exclusive neighbors based on a certain objective function.

In operation 1107, the proxy device starts proxy discovery messaging using transmit power, P_{P}.

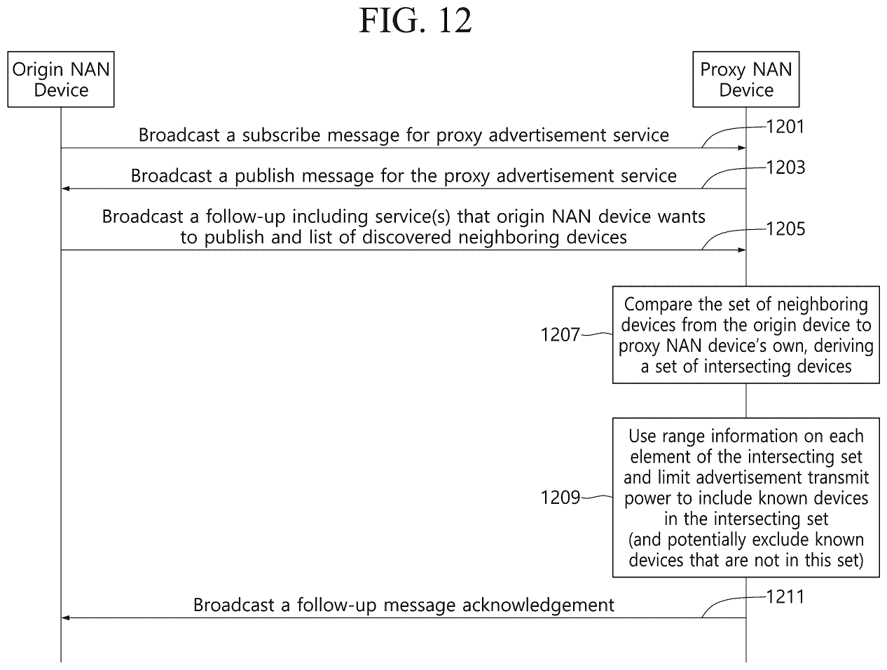

FIG. 12 illustrates an example communication for proxy power control calibration within NAN service discovery using shared neighboring device information in accordance with an embodiment.

At 1201, the origin NAN device broadcasts a subscribe message for proxy advertisement service to the proxy NAN device.

At 1203, the proxy NAN device broadcasts a publish message for the proxy advertisement service to the origin NAN device.

At 1205, the origin NAN device broadcasts a follow-up including service(s) that the origin NAN device wants to publish and a list of discovered neighboring devices.

At 1207, the proxy NAN device compares the set of neighboring devices from the origin device to proxy NAN device's own, deriving a set of intersecting devices

At 1209, the proxy NAN device uses range information on each element of the intersecting set and limits advertisement transmit power to include known devices in the intersecting set (and potentially exclude known devices that are not in this set)

At 1211, the proxy NAN device broadcasts a follow-up message acknowledgement to the origin NAN device.

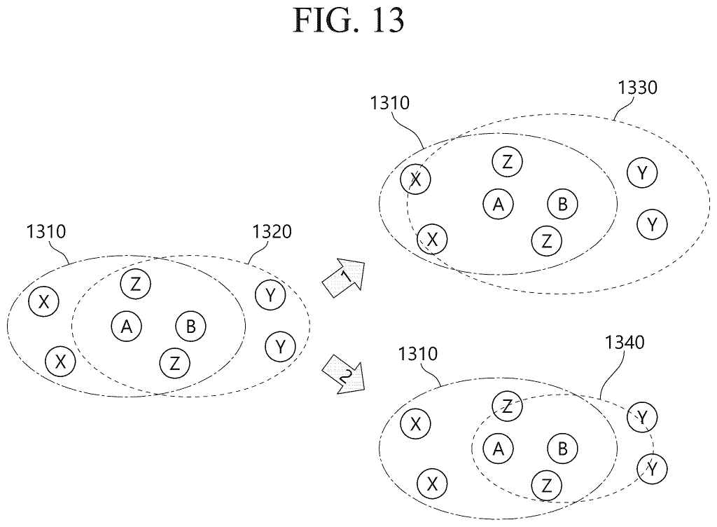

FIG. 13 illustrates proxy advertisement power adjustment configurations in accordance with an embodiment. In particular, in the left half of the figure, origin device A uses a proxy device B. Device A is in range of X devices and Z devices, but not Y devices, illustrated as region 1310. Proxy device B is in the range of Z devices and Y devices, but not X devices, illustrated as region 1320. This is the standard configuration. On the right half of the figure, two extremes of the proxy advertisement power adjustment using neighbor device information are shown.

In FIG. 13, the first adjustment extreme, denoted by arrow 1, shows the advertisement footprint of proxy device B, illustrated as region 1330, extending to cover all devices in range of device A. The second, denoted by arrow 2, shows the advertisement footprint of proxy device B, illustrated as region 1340, contracting to limit the range such that as many devices in range of device A can be covered while excluding devices that are only in range of device B. This can be achieved by device B noting the minimum receive power from devices that are neighbors of device A as well as the maximum receive power from devices that are neighbors of device B that are not neighbors of device A.

In some embodiments, the proxy device may use the set of neighboring devices of both the origin device and proxy device to set a list of eligible devices for connection.

In some embodiments, the origin device may share the set of its neighboring devices with the proxy device. The origin device may additionally share a signal strength metric for one or more devices in the neighboring devices set. The set of neighboring devices may be based on device ranging, or it may be based on other signals received from the neighboring devices, such as synchronization beacons, NAN discovery beacons, discovery messages, among others. With information on the origin device's neighboring device set, D, the proxy device can cross-reference with its own neighboring device information to derive a new set of devices that is the intersection of the origin and proxy device's neighboring device sets. The proxy device can append an additional “eligible devices” field that includes the set D. Devices that receive the proxy advertisement from the proxy device may then check the field of eligible devices and, if they are listed, can follow up with a response. Otherwise, they may ignore the message.

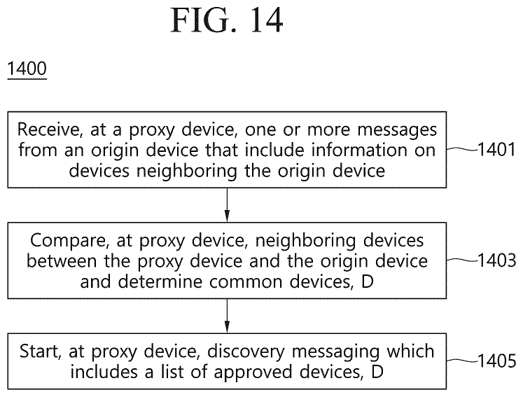

FIG. 14 illustrates an example flowchart for proxy device discovery control for radio devices through an eligible devices field using shared neighbor device information in accordance with an embodiment. The process 1400 at operation 1401, the proxy device receives one or more messages from an origin device that includes information on devices neighboring the origin device.

At operation 1403, the proxy device compares neighboring devices between the proxy device and the origin device and determines common devices, D.

At operation 1405, the proxy device starts discovery messaging which includes a list of approved devices, D.

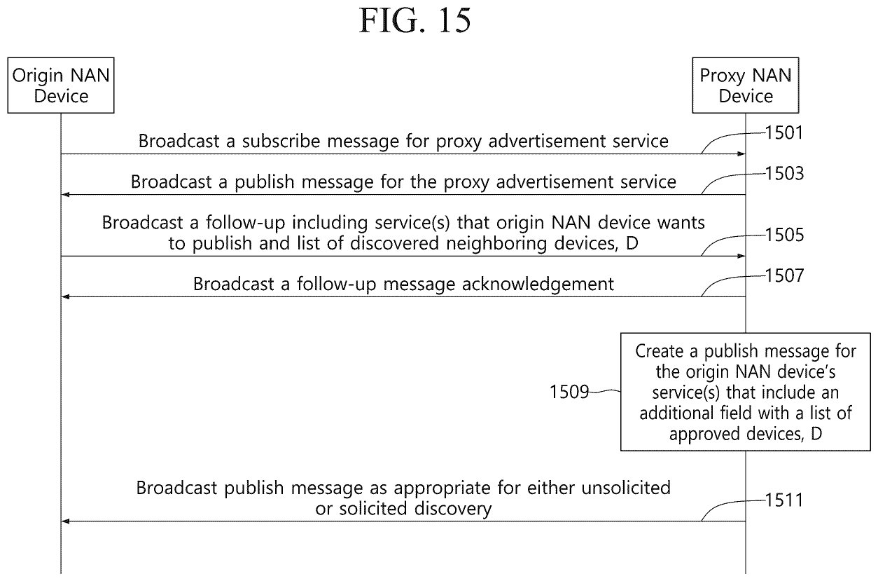

FIG. 15 illustrates an example communication for proxy device discovery control through an eligible devices field within NAN Service Discovery using shared neighboring device information in accordance with an embodiment.

At 1501, the origin NAN device broadcasts a subscribe message for proxy advertisement service to the proxy NAN device.

At 1503, the proxy NAN device broadcasts a publish message for the proxy advertisement service to the origin NAN device.

At 1505, the origin NAN device broadcasts a follow-up including service(s) that the origin NAN device wants to publish and a list of discovered neighboring devices, D.

At 1507, the proxy NAN device broadcasts a follow-up message acknowledgement to the origin NAN device.

At 1509, the proxy NAN device creates a publish message for the origin NAN device's service(s) that includes an additional field with a list of approved devices, D.

At 1511, the proxy NAN device broadcasts the publish message as appropriate for either unsolicited or solicited discovery.

In some embodiments, the proxy device may provide a range restriction in the discovery messaging to prevent ineligible devices from attempting to set up a data path for services.

In some embodiments, the proxy device may broadcast an initial message for the proxy advertisement service and the origin device may respond with a follow-up message that includes the service or services it would like published by the proxy along with a transmit power, P_{T}. The proxy device may receive this follow up message with received power, P_{S}. With transmit and received power of the origin device's message, an estimate of path loss between the two can be assumed as the difference between them. A target maximum distance for proxy advertisement can then be set as a function of the path loss between the origin device and the proxy device. The proxy device can then set a threshold for received power for devices receiving its proxy publication equal to the distance between its own transmit power and expected receive power for the target maximum distance. The received power threshold may then be attached to broadcasted messages resulting from the proxy advertisement service. Devices that receive the proxy advertisement from the proxy device may then check the messages' received power threshold and, if they fall in range, can follow up with a response. Otherwise, they may ignore the message.

Some embodiments may include aggregate advertisement messages. In particular, if multiple origin devices subscribe to the proxy advertisement service message of a single proxy device, an aggregate proxy advertisement message can be sent that includes the multiple services offered by multiple origin devices. Since each origin device could have a different derived received power threshold, the aggregate advertisement message may include multiple receive power thresholds corresponding to each origin device. Devices that receive the proxy advertisement from the proxy device may check the receive power threshold corresponding to the service they want to subscribe to and, if they fall in range, can follow up with a response. Otherwise, they may ignore the message.

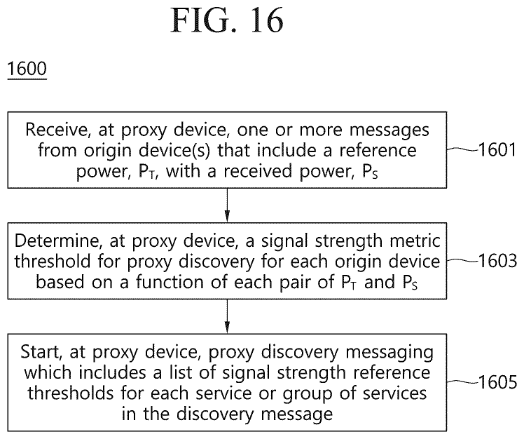

FIG. 16 illustrates an example flowchart for proxy device discovery control for radio devices through an eligible range field using origin device received signal strength in accordance with an embodiment. The process 1600, at operation 1601, the proxy device receives one or more message from origin device(s) that includes a reference power, P_{T}, with a received power, P_{S}.

At operation 1603, the proxy device determines a signal strength metric threshold for proxy discovery for each origin device based on a function of each pair of P_{T} and P_{S}.

At operation 1605, the proxy device starts proxy discovery messaging which includes a list of signal strength reference thresholds for each service or group of services in the discovery message.

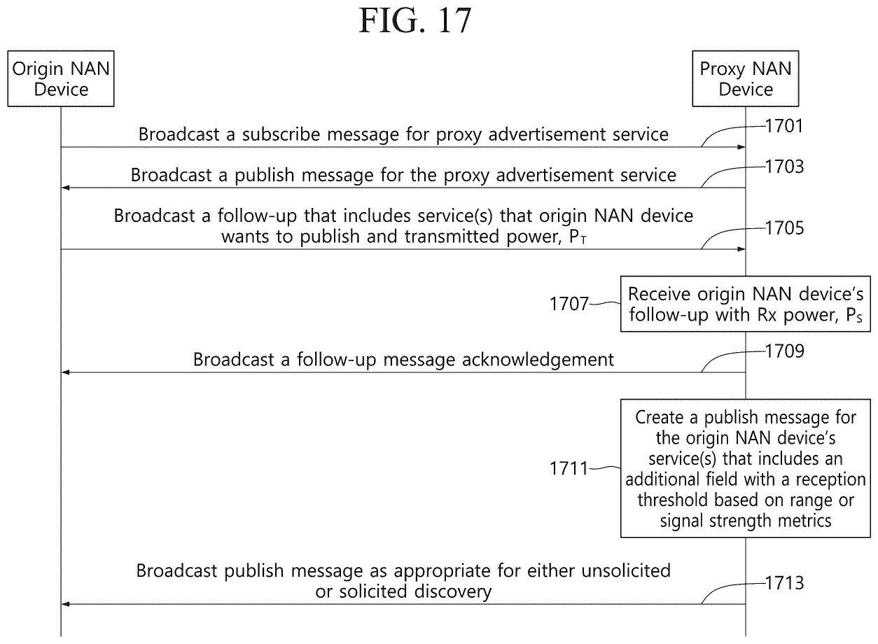

FIG. 17 illustrates an example communication for proxy device discovery control through an eligible range field within NAN service discovery using origin device received signal strength in accordance with an embodiment.

At 1701, the origin NAN device broadcasts a subscribe message for proxy advertisement service to the proxy NAN device.

At 1703, the proxy NAN device broadcasts a publish message for the proxy advertisement service to the origin NAN device.

At 1705, the origin NAN device broadcasts a follow-up including service(s) that the origin NAN device wants to publish and transmitted power, P_{T}.

At 1707, the proxy NAN device receives the origin NAN device's follow-up Rx power, P_{S}.

At 1709, the proxy NAN device broadcasts a follow-up message acknowledgement to the origin NAN device.

At 1711, the proxy NAN device creates a publish message for the origin NAN device's service(s) that includes an additional field with a reception threshold based on range or signal strength metrics.

At 1713, the proxy NAN device broadcasts the publish message as appropriate for either unsolicited or solicited discovery.

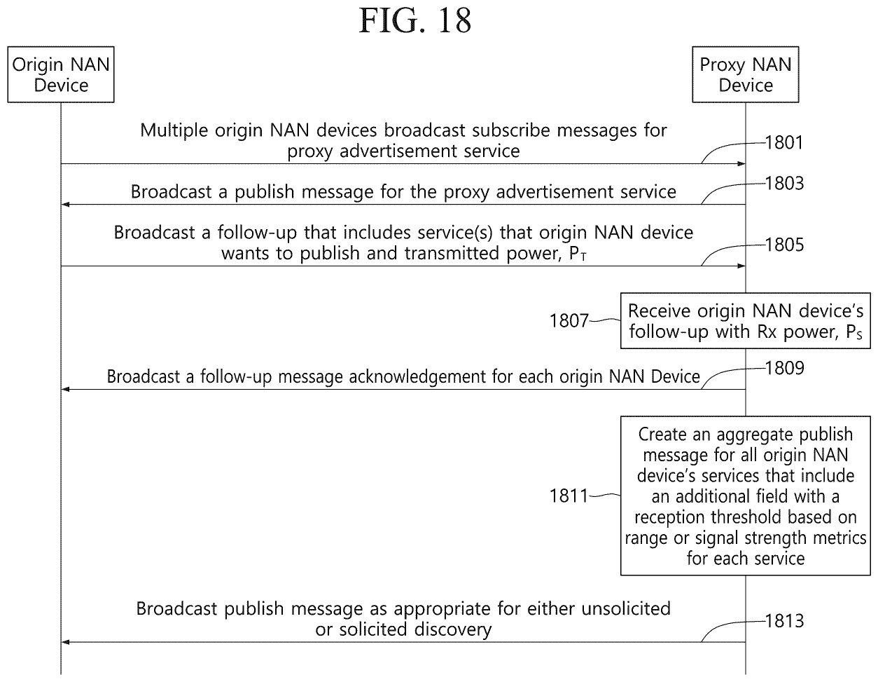

FIG. 18 illustrates an example communication for proxy device discovery in accordance with an embodiment. In particular, FIG. 18 illustrates proxy device discovery control for multiple origin devices through an eligible range field within NAN Service Discovery using origin device received signal strength in accordance with an embodiment.

At 1801, the multiple origin NAN device(s) broadcasts subscribe messages for proxy advertisement service to the proxy NAN device.

At 1803, the proxy NAN device broadcasts a publish message for the proxy advertisement service to the origin NAN device(s).

At 1805, the origin NAN device(s) broadcast a follow-up including service(s) that the origin NAN device wants to publish and transmitted power, P_{T}.

At 1807, the proxy NAN device receives the origin NAN device's follow-up Rx power, P_{S}.

At 1809, the proxy NAN device broadcasts a follow-up message acknowledgement for each origin NAN device.

At 1811, the proxy NAN device creates a publish message for all origin NAN device's services that includes an additional field with a reception threshold based on range or signal strength metrics for each service.

At 1813, the proxy NAN device broadcasts the publish message as appropriate for either unsolicited or solicited discovery.

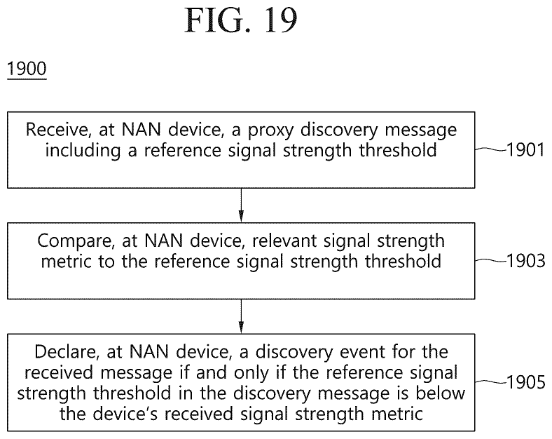

FIG. 19 illustrates an example flowchart for reception of a proxy discovery message and discovery event decision using range restriction in accordance with an embodiment. The process 1900, at operation 1901, the NAN device receives a proxy discovery message that includes a reference signal strength threshold.

At operation 1903, the NAN device compares a received signal strength metric to the reference signal strength threshold.

At operation 1905, the NAN device declares a discovery event for the received message if and only if the reference signal strength threshold in the discovery message is below the device's received signal strength metric.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

As described herein, any electronic device and/or portion thereof according to any example embodiment may include, be included in, and/or be implemented by one or more processors and/or a combination of processors. A processor is circuitry performing processing.

Processors can include processing circuitry, the processing circuitry may more particularly include, but is not limited to, a Central Processing Unit (CPU), an MPU, a System on Chip (SoC), an Integrated Circuit (IC) an Arithmetic Logic Unit (ALU), a Graphics Processing Unit (GPU), an Application Processor (AP), a Digital Signal Processor (DSP), a microcomputer, a Field Programmable Gate Array (FPGA) and programmable logic unit, a microprocessor, an Application Specific Integrated Circuit (ASIC), a neural Network Processing Unit (NPU), an Electronic Control Unit (ECU), an Image Signal Processor (ISP), and the like. In some example embodiments, the processing circuitry may include: a non-transitory computer readable storage device (e.g., memory) storing a program of instructions, such as a DRAM device; and a processor (e.g., a CPU) configured to execute a program of instructions to implement functions and/or methods performed by all or some of any apparatus, system, module, unit, controller, circuit, architecture, and/or portions thereof according to any example embodiment and/or any portion of any example embodiment. Instructions can be stored in a memory and/or divided among multiple memories.

Different processors can perform different functions and/or portions of functions. For example, a processor 1 can perform functions A and B and a processor 2 can perform a function C, or a processor 1 can perform part of a function A while a processor 2 can perform a remainder of function A, and perform functions B and C. Different processors can be dynamically configured to perform different processes. For example, at a first time, a processor 1 can perform a function A and at a second time, a processor 2 can perform the function A. Processors can be located on different processing circuitry (e.g., client-side processors and server-side processors, device-side processors and cloud-computing processors, among others).

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

1. A method for messaging in a wireless network, comprising:
receiving, by a proxy device for an origin device, a first message from the origin device, wherein the first message includes a reference transmit power of the origin device and the first message is received with a received power;
computing, by the proxy device, a transmit power for transmitting messages on behalf of the origin device based on the reference transmit power and the received power; and
transmitting at the transmit power, by the proxy device, a second message to a plurality of devices that includes information about a service provided by the origin device.

2. The method of claim 1, wherein the received power is based on a received signal strength of the first message.

3. The method of claim 1, wherein the transmit power is computed such that the second message is received by a set of neighboring devices to the origin device.

4. The method of claim 3, wherein the set of neighboring devices to the origin device are determined based on ranging information provided in Neighbor Awareness Networking (NAN).

5. The method of claim 1, wherein the transmit power is computed such that the second message is received by a set of neighboring devices that are in common to the origin device and the proxy device.

6. The method of claim 5, wherein the first message includes information on one or more devices neighboring the origin device, wherein the method further comprises:
comparing, by the proxy device, one or more neighboring devices between the proxy device and the origin device to determine the set of neighboring devices that are in common to the origin device and the proxy device and to determine a set of neighboring devices that are exclusive to the proxy device; and
computing, by the proxy device, the transmission power to include the set of neighboring devices that are in common and to exclude the set of neighboring devices that are exclusive to the proxy device.

7. The method of claim 1, wherein the first message includes signal strength information for a set of neighboring devices of the origin device and the second message includes the signal strength information for the set of neighboring devices of the origin device.

8. The method of claim 1, further comprising determining a signal strength threshold for transmitting a message for the origin device by:
computing an estimate path lost between the origin device and the proxy device based on a difference between the transmit power and the received power;
computing a target maximum distance for transmitting messages as a function of the estimated path loss;
setting the signal strength threshold for received power for devices receiving the second message equal to a distance between the transmit power of the proxy device and expected receive power for the target maximum distance; and
including the signal strength threshold in the second message.

9. The method of claim 1, further comprising:
receiving, by the proxy device, a third message from a different origin device; and
transmitting, by the proxy device, a fourth message that includes information about the service provided by the origin device and information about a service provided by the different origin device.

10. The method of claim 1, further comprising using a machine learning model to determine the transmit power.

11. A first station (STA) in a wireless network, the first STA comprising:
a memory;
a processor coupled to the memory, the processor configured to:
receive, a first message from a second STA, wherein the first message includes a reference transmit power of the second STA and the first message is received with a received power;
compute a transmit power for transmitting messages on behalf of the second STA based on the reference transmit power and the received power; and
transmit at the transmit power a second message to a plurality of STAs that includes information about a service provided by the second STA.

12. The first STA of claim 11, wherein the received power is based on a received signal strength of the first message.

13. The first STA of claim 11, wherein the transmit power is computed such that the second message is received by a set of neighboring STAs to the second STA.

14. The first STA of claim 13, wherein the set of neighboring STAs to the second STA device are determined based on ranging information provided in Neighbor Awareness Networking (NAN).

15. The first STA of claim 11, wherein the transmit power is computed such that the second message is received by a set of neighboring STAs that are in common to the first STA device and the second STA.

16. The first STA of claim 15, wherein the first message includes information on one or more STAs neighboring the second STA, wherein the processor is further configured to:
compare neighboring STAs between the first STA and the second STA to determine the set of neighboring STAs that are in common to the first STA and the second STA and to determine a set of neighboring STAs that are exclusive neighbors to the first STA; and
compute the transmission power to include the set of neighboring STAs that are in common and to exclude the set of neighboring STAs that are exclusive neighbors to the first STA.

17. The first STA of claim 11, wherein the first message includes signal strength information for a set of neighboring STAs of the second STA and the second message includes the signal strength information for the set of neighboring STAs of the second STA.

18. The first STA of claim 11, wherein the processor is further configured to:
determine a signal strength threshold for transmitting a message for the second STA by:
computing an estimate path lost between the second STA device and the first STA based on a difference between the transmit power and the received power;
computing a target maximum distance for transmitting messages as a function of the estimated path loss;
setting the signal strength threshold for received power for STAs receiving the second message equal to a distance between the transmit power of the first STA and expected receive power for the target maximum distance; and
including the signal strength threshold in the second message.

19. The first STA of claim 11, wherein the processor is further configured to:
receive a third message from a third STA; and
transmit a fourth message that includes information about the service provided by the second STA and information about a service provided by the third STA.

20. The first STA of claim 11, wherein the processor is further configured to use a machine learning model to determine the transmit power.
